(19) United States
(12) Patent Application Publication
(10) Pub. No.: US 2014/0175915 A1
(43) Pub. Date: Jun. 26, 2014

(54) MOTOR OF OUTER ROTOR TYPE

(71) Applicant: SAMSUNG ELECTRO-MECHANICS CO., LTD., Suwon-si (KR)

(72) Inventor: Hyun Kag PARK, Suwon-si (KR)

(73) Assignee: SAMSUNG ELECTRO-MECHANICS CO., LTD., Suwon-si (KR)

(21) Appl. No.: 14/138,803

(22) Filed: Dec. 23, 2013

(30) Foreign Application Priority Data
Dec. 24, 2012 (KR) 10-2012-0152297

(51) Int. Cl. H02K 5/24

(52) U.S. Cl. CPC H02K 5/24
USPC 310/51

(57) ABSTRACT

Disclosed herein is a motor of an outer rotor type, including: a shaft; a bearing assembly rotatably supporting the shaft; a stator portion disposed at an outer side of the bearing assembly; a rotor portion including a cylindrical back yoke and a magnet disposed at an inner circumferential surface of the back yoke and disposed at a predetermined interval from the stator portion; and a fan assembly including a cylindrical hub fixing the shaft and a plurality of blades extending radially on an outer circumferential surface of the hub, wherein the inner circumferential surface of the back yoke is formed in an embossed shape using a plurality of arcs to form a space portion between the back yoke and the magnet.

### CROSS REFERENCE TO RELATED APPLICATION

This application claims the benefit of Korean Patent Application No. 10-2012-0152297, filed on Dec. 24, 2012, entitled “Motor of Outer Rotor Type” which is hereby incorporated by reference in its entirety into this application.

### BACKGROUND OF THE INVENTION

1. Technical Field

The present invention relates to a motor of an outer rotor type.

2. Description of the Related Art

A drum washing machine is classified into an indirect driving type of a belt connection type delivering a driving force of a motor to a drum through a belt wound around a motor pulley and a drum pulley and a direct driving type directly delivering a driving force to the drum of the motor, according to a driving method.

The drum washing machine driven by an indirect driving type of the foregoing belt connection type fixes a pulley to a shaft press-fitted in a rotor portion to drive a belt and generally uses a motor of an inner rotor type.

However, the drum washing machine driven by the indirect driving type of the belt connection type does not directly deliver a driving force of a motor to a drum but indirectly deliver a driving force through a belt wound around a motor pulley and a drum pulley, such that it cannot help involving an energy loss and a lot of noise during a power delivery process.

In order to solve the problems, the drum washing machining really uses a motor of an outer rotor type, instead of the inner rotor.

An example of the outer rotor is disclosed in Patent Document 1.

A motor disclosed in Patent Document 1 includes an outer rotor in which an inner side of a yoke portion is provided with a ring-shaped magnet.

In summary, the motor according to the related art includes a magnet in which a plurality of magnetic pole portions having central parts maximally protruded are connected to have a ring shape.

The magnet oppositely arranged to a stator has a complicated section shape and requires a precise size and shape so as to be certainly magnetized on the inner side of the yoke portion as well as has a brittle structure due to a protruded shape, such that it is difficult to achieve stable characteristics of the motor. A need exists for another method for solving the problem.

### PRIOR ART DOCUMENT

### Patent Document

(Patent Document 1) Patent Document 1: JP Patent Laid-Open Publication No. 2001-95185

### SUMMARY OF THE INVENTION

The present invention has been made in an effort to increase output or counter electromotive force from a motor of an outer rotor type and reduce a cogging torque and a noise.

According to a preferred embodiment of the present invention, there is provided a motor of an outer rotor type, including: a shaft; a bearing assembly rotatably supporting the shaft; a stator portion disposed at an outer side of the bearing assembly; a rotor portion including a cylindrical back yoke and a magnet disposed at an inner circumferential surface of the back yoke and disposed at a predetermined interval from the stator portion; and a fan assembly including a cylindrical hub fixing the shaft and a plurality of blades extending radially on an outer circumferential surface of the hub, wherein the inner circumferential surface of the back yoke is formed in an embossed shape using a plurality of arcs to form a space portion between the back yoke and the magnet.

The arc may be protruded inwardly toward the center of the shaft and include a maximum thickness portion most protruded at a central portion thereof and a minimum thickness portion disposed at both edges thereof.

The space portion may be formed by magnetizing the magnet at the maximum thickness portion of the arc.

A thickness of a convex shape portion in the arc may have a difference between a thickness of the maximum thickness portion and a thickness of the minimum thickness portion and the arc is protruded as many as the thickness difference.

The thickness of the convex shape portion may have a length of 30% or more of the thickness of the minimum thickness portion.

The magnet may have a ring shape and an inner diameter and an outer diameter of the to magnet may have the same curvature.

The magnet may have a thickness of 90% or more of the thickness of the maximum thickness portion of the arc.

The arc may form an arc angle between two minimum thickness portions disposed at both edges thereof and the arc angle may be formed in the number of 360°/poles.

The back yoke may be formed of a magnetic material to form a magnetic path in the motor of the outer rotor type.

The space portion may be filled with a non-magnetic material, for example, air.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of an outer rotor type according to an embodiment of the present invention;

FIG. 2 is a transverse cross-sectional view of an outer rotor portion illustrated in FIG. 1; and

FIGS. 3A and 3B are magnetization distribution diagrams of the present invention and the prior art.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a motor of an outer rotor type according to the present invention will be described in detail with reference to the accompanying drawings.

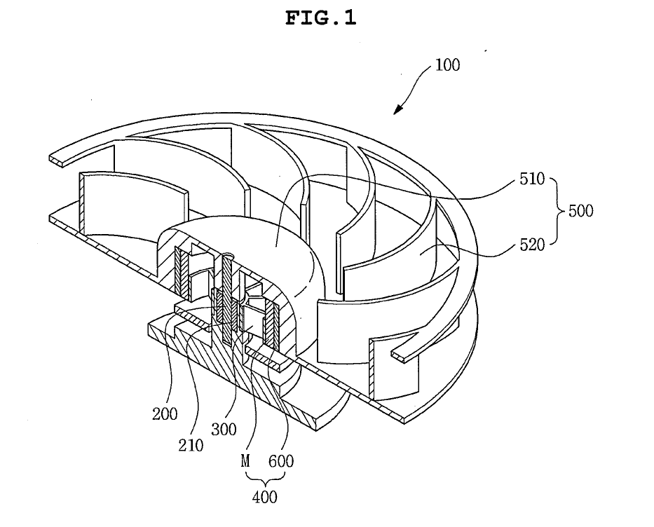

Referring to FIG. 1, the preferred embodiment of the present invention relates to a motor 100 of an outer rotor type including a stator portion 300 and a rotor portion 400. That is, the preferred embodiment of the present invention relates to an outer rotor type having the stator portion 300 disposed at an inner side thereof and the rotor portion 400 disposed at an outer side of the stator portion 300.

In detail, a motor 100 of the preferred embodiment of the present invention is configured of a shaft 200, a bearing assembly 210 rotatably supporting the shaft 200, a stator portion 300 disposed at the outer side of the bearing assembly 210, a rotor portion 400 disposed in a cylindrical shape at a predetermined interval from the stator portion 300, and a fan assembly 500 disposed at an outer surface of the rotor portion 400.

The bearing assembly 210 generally has a cylindrical shape and rotatably supports the shaft 200 therein.

The stator portion 300 is rotatably received in a hollow portion of the rotor portion 400 and includes a through hole of which the center is provided with a through path of the shaft 200.

The fan assembly 500 is generally formed of a synthetic resin material and has a cylindrical shape and includes a hub 510 fixing the shaft 200 and a plurality of blades 520 that extend radially on an outer circumferential surface of the hub 510.

In the present invention, a back yoke 600 is mounted on an inner circumferential surface of the hub 510, while the inner side of the back yoke 600 is provided with a ring-shaped or cylindrical magnet M that keeps a predetermined interval from the stator portion 300.

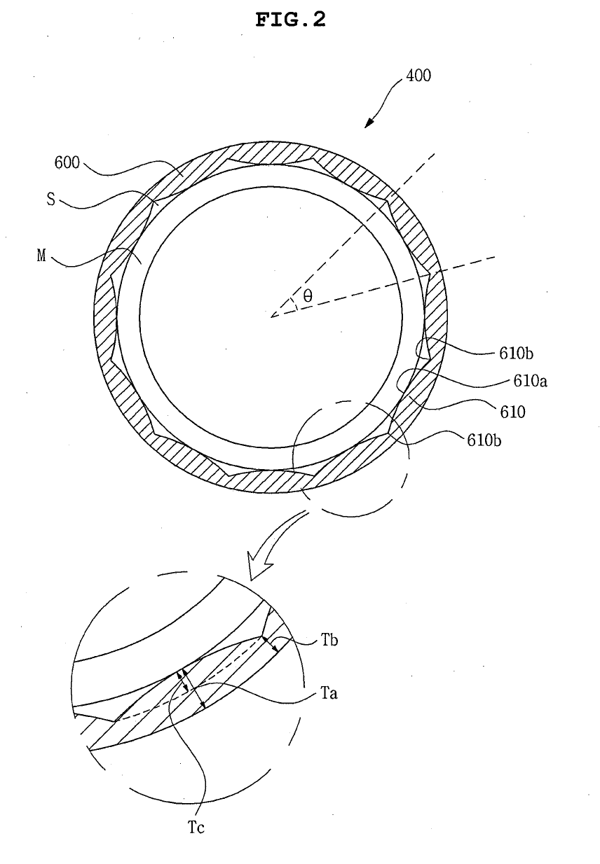

In FIG. 2, the outer rotor portion 400 according to the present invention includes a magnet M that is disposed in the inner side of the general cylindrical back yoke 600. In addition, the magnet M has a ring shape or a cylindrical shape of which the curvatures of the inner circumferential surface and the outer circumferential surface are the same.

Preferably, the present invention includes a plurality of arcs 610 that are protruded toward a center of the shaft 200 (see FIG. 1) in the inner circumferential surface of the back yoke 600. In particular, the motor according to the preferred embodiment of the present invention has a space portion S formed between the back yoke 600 and the magnet M at a predetermined interval.

As illustrated, the arc 610 is formed in a convex shape portion that is protruded toward the center of the shaft and is constantly arranged along the inner circumferential surface of the back yoke 600. As described above, the arc 610 is configured to have a maximum thickness portion 610a that is protruded most at a central part thereof and a minimum thickness portion 610b arranged at both edges thereof, in which the minimum thickness portion 610b communicates with the minimum thickness portion 610b of another arc 610 adjacent to thereto and is formed of a magnetic material forming a magnetic circuit.

As described above, the back yoke 600 including the plurality of convex arcs 610 provides a space portion S at the outer side of the magnet M through the embossed shape of the maximum thickness portion 610a and the minimum thickness portion 610b. Further, a difference between a thickness Ta of the maximum thickness portion 610a and a thickness Tb of the minimum thickness portion 610b in the arc 610 represents a thickness Tc of the convex shape portion of the ring-shaped back yoke, in other words, Ta=Tb+Tc. In other words, the minimum thickness portion 610b represents the thickness Tb of the ring-shaped back yoke 600 from which the arc 610 is excluded and the maximum thickness portion 610a represents a length from the outer circumferential surface of the ring-shaped back yoke 600 to the central part of the convex arc 610.

Preferably, the thickness Tc of the convex shape portion has a length of 30% or more of the thickness Tb of the minimum thickness portion 610b. As such, the preferred embodiment of the present invention may provide an embossed shape on the inner circumferential surface of the back yoke 600 due to the thickness Tc of the convex shape portion, for example, the thickness difference as described above and may have between the maximum thickness portion 610a and the minimum thickness portion 610b curved.

In addition, since the preferred embodiment of the present invention needs to consider the thickness of the magnet M mounted in the back yoke 600 capable of minimizing the cogging torque, the thickness of the magnet M becomes 90% or more of the thickness of the back yoke 600, in more detail, the thickness Ta of the maximum thickness portion 610a.

The inside of the so formed space portion S may be filled with a non-magnetic material, for example, air to control a magnetization direction between the magnet M and the back yoke 600.

In particular, an arc angle θ of the arc 610 is formed in the number of 360°/pole. Herein, the arc angle represents a single pole in the magnet M.

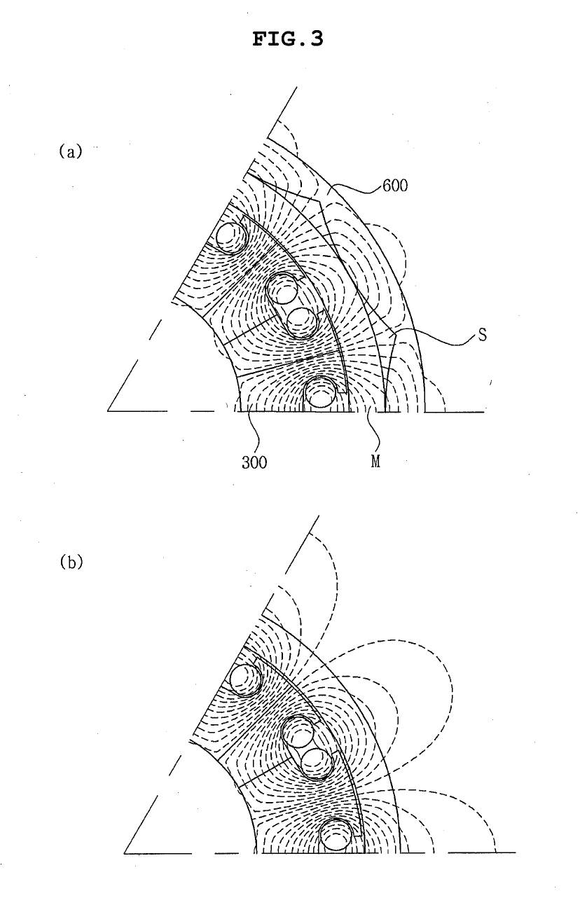

FIG. 3A is a magnetization distribution diagram of the present invention providing the space portion S between the back yoke 600 and the magnet M and FIG. 3B is a magnetization distribution diagram according to the prior art in which the magnet is magnetized on the back yoke, without including a separate space portion between the back yoke and the magnet.

When comparing with the prior art, it can be confirmed that the motor according to the preferred embodiment of the present invention reduces a magnetized quantity leaked to the outer circumferential surface of the back yoke 600. Consequently, the motor 100 according to the preferred embodiment of the present invention further increases the magnetized quantity of the magnet M generating around the inner circumferential surface of the magnet M, and thus brings about the increase in counter electromotive force.

The motor 100 according to the preferred embodiment of the present invention partially induces the magnetization direction of the magnet M magnetized on the inner circumferential surface of the back yoke 600 to the space portion S filled with a non-magnetic material to maximize the magnetization efficiency between the magnet M and the stator portion 300 and reduce the sudden change in magnetic flux, thereby reducing the cogging torque of the motor 100 of the outer rotor type.

Further, the preferred embodiment of the present invention brings about the increase in counter electromotive force due to the design of the back yoke 600 as described above, thereby reducing the used amount of the magnet M and miniaturizing the volume of the motor.

As set forth above, according to the preferred embodiment of the present invention, it is possible to improve the output and the counter electromotive force from the motor and remarkably reduce the cogging torque and the noise, by forming the space portion between the back yoke required to form the magnetic path and the magnet magnetized in the inner side thereof.

Further, the present invention has been made in an effort to reduce a used amount of magnet to minimize a volume of a motor at low cost.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A motor of an outer rotor type, comprising:
a shaft;
a bearing assembly rotatably supporting the shaft;
a stator portion disposed at an outer side of the bearing assembly;
a rotor portion including a cylindrical back yoke and a magnet disposed at an inner circumferential surface of the back yoke and disposed at a predetermined interval from the stator portion; and
a fan assembly including a cylindrical hub fixing the shaft and a plurality of blades extending radially on an outer circumferential surface of the hub,
wherein the inner circumferential surface of the back yoke is formed in an embossed shape using a plurality of arcs to form a space portion between the back yoke and the magnet.

2. The motor of an outer rotor type as set forth in claim 1, wherein the arc includes a maximum thickness portion most protruded at a central portion thereof and a minimum thickness portion disposed at both edges thereof and is protrudedly curved based on a center of a shaft through the maximum thickness portion and the minimum thickness portion.

3. The motor of an outer rotor type as set forth in claim 1, wherein a thickness of a convex shape portion in the arc has a difference between a thickness of the maximum thickness portion and a thickness of the minimum thickness portion.

4. The motor of an outer rotor type as set forth in claim 3, wherein the thickness of the convex shape portion has a length of 30% or more of the thickness of the minimum thickness portion.

5. The motor of an outer rotor type as set forth in claim 1, wherein the magnet has a ring shape and an inner diameter and an outer diameter of the magnet have the same curvature.

6. The motor of an outer rotor type as set forth in claim 1, wherein the magnet has a thickness of 90% or more of the thickness of the maximum thickness portion of the arc.

7. The motor of an outer rotor type as set forth in claim 2, wherein the arc forms an arc angle between two minimum thickness portions disposed at both edges thereof and the arc angle is formed in the number of 360°/poles.

8. The motor of an outer rotor type as set forth in claim 1, wherein the back yoke is formed of a magnetic material.

9. The motor of an outer rotor type as set forth in claim 1, wherein the space portion is filled with a non-magnetic material.

10. The motor of an outer rotor type as set forth in claim 1, wherein the space portion is filled with air.

11. The motor of an outer rotor type as set forth in claim 1, wherein the magnet is magnetized at the maximum thickness portion in the arc of the back yoke.
